(19) United States
(12) Patent Application Publication
(10) Pub. No.: US 2007/0222897 A1
(43) Pub. Date: Sep. 27, 2007

(54) Receiver apparatus and receiver system

(75) Inventor: Tsutomu Jitsuhara, Osaka (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/606,959

(22) Filed: Dec. 1, 2006

(30) Foreign Application Priority Data
Mar. 27, 2006 (JP) 2006-085133

(51) Int. Cl. H04N 5/46

(52) U.S. Cl. 348/729

(57) ABSTRACT

According to the present invention, in a receiver apparatus that converts a radio-frequency signal received via an antenna into video and audio signals, there are arranged on a circuit board: a tuner circuit portion that converts the radio-frequency signal received via the antenna into an intermediate-frequency signal, which is to be outputted; a digital demodulating portion that converts the intermediate-frequency signal outputted from the tuner circuit portion into a compressed digital signal, which is to be outputted; a digital circuit portion that converts the compressed digital signal outputted from the digital demodulating portion into digital video and audio signals, which are to be outputted; and a video/audio output circuit that converts the digital video and audio signals outputted from the digital circuit portion into analog video and audio signals. This makes it possible to realize a receiver system provided with a video display apparatus having a simple configuration.

This nonprovisional application claims priority under 35 U.S.C. § 119(a) on Patent Application No. 2006-085133 filed in Japan on Mar. 27, 2006, the entire contents of which are hereby incorporated by reference.

### BACKGROUND OF THE INVENTION

1. Field of the Invention

The present invention relates to a receiver apparatus and a receiver system for receiving a radio-frequency signal such as a digital television broadcasting signal.

2. Description of Related Art

FIG. 4 is a block diagram showing an outline of the configuration of an example of a conventional receiver system. The receiver system 900 shown in FIG. 4 is composed of: an antenna 901 via which a radio-frequency signal is received; a receiver apparatus 902 for performing predetermined processing on the signal received via the antenna 901 to obtain a desired signal; and a video display apparatus 903 for performing predetermined processing on the signal obtained by the receiver apparatus 902 to extract video and audio signals.

The receiver apparatus 902 is provided with: a tuner circuit portion 911 that converts the radio-frequency signal received via the antenna 901 into an intermediate-frequency signal, which is to be outputted; a digital demodulating portion 912 that converts the intermediate-frequency signal outputted from the tuner circuit portion 911 into a compressed digital signal; and a power supply portion 913 that feeds the tuner circuit portion 911 and the digital demodulating portion 912 with electric power from which they operate. The digital demodulating portion 912 is provided with a digital demodulating IC 914, which is a processing IC for converting the intermediate-frequency signal into a digital signal.

The video display apparatus 903 is provided with: a digital circuit portion 921 that converts the compressed digital signal fed from the receiver apparatus 902 into digital video and audio signals, which are to be outputted; a video/audio output circuit 922 that converts the digital video and audio signals outputted from the digital circuit portion 921 into analog video and audio signals; a display processing portion 923 that performs processing for displaying video based on the analog video signal outputted from the video/audio output circuit 922; an audio processing portion 924 that performs processing for outputting audio based on the analog audio signal outputted from the video/audio output circuit 922; and a power supply portion 925 that feeds the digital circuit portion 921, the video/audio output circuit 922, the display processing portion 923, and the audio processing portion 924 with electric power from which they operate. The digital circuit portion 921 is provided with: a video/audio processing IC 928 for extracting video and audio signals from the compressed digital signal; a video/audio processing memory 926 for temporarily storing data being processed during video/audio processing; and a program memory 927 for storing control codes for controlling the receiver apparatus.

In this conventional receiver system 900 configured as described above, the receiver apparatus 902 is electromagnetically shielded by being covered with a shield. On the other hand, the video display apparatus 903 has many functional sections mounted on the circuit board thereof, namely the video/audio processing IC 928, the video/audio processing memory 926, the program memory 927, the video/audio output circuit 922, the display processing portion 923, and the audio processing portion 924. This requires an accordingly large number of components and conductors to be mounted and laid on the circuit board of the video display apparatus 903, which thus necessitates the use of a multiple-layer circuit board.

Furthermore, the above-mentioned functional sections mounted on the circuit board of the video display apparatus 903, namely the video/audio processing IC 928, the video/audio processing memory 926, the program memory 927, the video/audio output circuit 922, the display processing portion 923, and the audio processing portion 924, generate unnecessary electromagnetic emission and noise, against which measures need to be taken in the video display apparatus 903, and hence an additional shield is required to be provided.

Moreover, the above-mentioned functional sections mounted on the circuit board of the video display apparatus 903, namely the video/audio processing IC 928, the video/audio processing memory 926, the program memory 927, the video/audio output circuit 922, the display processing portion 923, and the audio processing portion 924, also generate heat, against which measures need to be taken as by increasing the area of the circuit board or providing it with an additional heat-dissipating plate.

### SUMMARY OF THE INVENTION

The present invention has been made to solve the above described problems, and it is an object of the present invention to provide a receiver system provided with a video display apparatus having a simple configuration.

To achieve the above object, according to one aspect of the present invention, a receiver apparatus that converts a radio-frequency signal received via an antenna into video and audio signals is provided with: a tuner circuit portion that converts the radio-frequency signal received via the antenna into an intermediate-frequency signal; a digital demodulating portion that converts the intermediate-frequency signal outputted from the tuner circuit portion into a compressed digital signal; a digital circuit portion that converts the compressed digital signal outputted from the digital demodulating portion into digital video and audio signals; and a video/audio output circuit that converts the digital video and audio signals outputted from the digital circuit portion into analog video and audio signals. Here, the tuner circuit portion, the digital circuit portion, the digital demodulating portion, and the video/audio output circuit are arranged on a single circuit board (a first configuration).

Since the digital circuit portion and the video/audio output circuit are mounted on the circuit board of the receiver apparatus as described above, a video display apparatus that displays video based on a video signal outputted from the receiver apparatus and/or outputs audio based on an audio signal outputted from the receiver apparatus needs only to be provided with: a display processing portion that displays video based on a video signal inputted from the receiver apparatus; and an audio processing portion that outputs audio based on an audio signal inputted from the receiver apparatus. This makes it possible to realize the video display apparatus with a single-layer circuit board instead of a multiple-layer circuit board. Furthermore, measures against the heat generated by the digital circuit portion and the video/audio output circuit can be taken in the receiver apparatus, and hence, in the video display apparatus, no measures need to be taken against heat as by increasing the area of the circuit board or providing it with an additional heat-dissipating plate.

Moreover, with this configuration, in which the tuner circuit portion, the digital circuit portion, the digital demodulating portion, and the video/audio output circuit are arranged on a circuit board, it is possible to realize a receiver apparatus with a simple configuration.

Also, in the first configuration described above, the analog ground pattern of the block including the tuner circuit portion and the digital ground pattern of the block including the digital circuit portion, the digital demodulating portion, and the video/audio output circuit may be arranged apart from each other on the circuit board (a second configuration).

Also, the circuit board may be housed in a chassis, and the analog ground pattern and the digital ground pattern may be electrically connected to the chassis (a third configuration).

Also, the digital circuit portion may include: a video/audio processing IC that demodulates compressed digital video and audio signals; and a video/audio processing memory that stores compressed digital video and audio signals and demodulated digital video and audio signals, and on the circuit board, the video/audio processing memory may be arranged in an end part of the circuit board opposite from an end part thereof where the tuner circuit portion is mounted, on a face of the circuit board opposite to a face thereof on which the video/audio processing IC is mounted (a fourth configuration).

In the conventional configuration, since the digital circuit portion is provided in the video display apparatus, measures against the unnecessary electromagnetic and the noise generated by the video/audio processing IC, the video/audio processing memory, the program memory, and the like need to be taken in the video display apparatus. By contrast, with the configuration according to the present invention, the digital circuit portion is provided in the receiver apparatus, and thus the video display apparatus can be configured without a digital circuit portion. This eliminates the need to take measures against unnecessary electromagnetic emission and noise in the video display apparatus. Furthermore, this configuration prevents the digital noise generated by the video/audio processing memory from entering the tuner circuit portion arranged on the circuit board, and thus helps prevent degradation of the performance of the tuner circuit portion.

Incidentally, the word “opposite” here relates to a relative positional relationship on the circuit board, and denotes “opposite with respect to the substantial center of the circuit board”.

Also, the digital demodulating portion may include a digital demodulating IC, which is a processing IC for converting an intermediate-frequency signal into a digital signal, and on the circuit board, the digital demodulating IC and the video/audio processing IC may be arranged apart from each other on a same mount face (a fifth configuration).

This permits the heat generated by the digital demodulating IC and the heat generated by the video/audio processing IC to spread out.

Also, on the circuit board, the digital demodulating IC and the video/audio processing IC may each make contact with the chassis via a thermally conductive member laid in between (a sixth configuration).

This permits the heat generated by the digital demodulating IC and the heat generated by the video/audio processing IC to be dispersed to the chassis and a lid of the circuit board, and thus helps alleviate the accumulation of the heat on the circuit board.

Also, the circuit board may be a multiple-layer circuit board, and the video/audio processing IC and the video/audio processing memory may be wired together via an interlayer conductor pattern (a seventh configuration).

This prevents the unnecessary electromagnetic generated by the video/audio processing memory.

Also, the circuit board may be a multiple-layer circuit board, and the video/audio processing IC and the digital demodulating IC may be wired together via an interlayer conductor pattern (an eighth configuration).

This helps prevent the unnecessary electromagnetic emission generated by the digital demodulating IC.

Also, on the circuit board, along one edge thereof may be arranged a connector that includes input and output terminals of the tuner circuit portion, the digital demodulating portion, the digital circuit portion, and the video/audio output circuit (a ninth configuration).

Also, within the connector, an output terminal and a ground terminal of the video/audio output circuit may be arranged in a part of the connector opposite from the tuner circuit portion (a tenth configuration).

This helps prevent the radio-frequency noise generated by the tuner circuit portion on the circuit board from entering the video/audio output circuit. Incidentally, the word “opposite” here relates to a relative positional relationship within the connector, and denotes “opposite with respect to the substantial center of the circuit board”.

Also, within the connector, an IF output terminal that outputs an intermediate-frequency signal obtained through conversion by the tuner circuit portion may be arranged near the tuner circuit portion (an eleventh configuration).

This helps prevent the digital noise generated by the digital demodulating portion and the digital circuit portion from mixing with the intermediate-frequency signal outputted from the tuner circuit portion. Incidentally, the phrase “near the tuner circuit portion” here relates to a relative positional relationship within the connector, and denotes “near that part of the connector which is located on that side of substantially the center thereof where the tuner circuit portion is located”.

Also, a power supply portion may be provided that feeds electric power to each of the tuner circuit portion, the digital demodulating portion, the digital circuit portion, and the video/audio output circuit, and within the connector, power supply terminals for feeding electric power to the tuner circuit portion, the digital demodulating portion, the digital circuit portion, and the video/audio output circuit may be arranged between the output terminal of the video/audio output circuit and the IF output terminal (a twelfth configuration).

Also, a block including the tuner circuit portion may be separated from a block including the digital circuit portion, the digital demodulating portion, and the video/audio output circuit with a first shield plate (a thirteenth configuration).

This helps prevent the electromagnetic emission generated by the digital demodulating portion and the digital circuit portion on the circuit board from entering the tuner circuit portion.

Also, on the circuit board, the digital demodulating portion and the digital circuit portion may be separated from each other with a second shield plate (a fourteenth configuration).

This helps prevent the electromagnetic emission generated by the digital circuit portion from entering the digital demodulating portion.

According to another aspect of the present invention, a receiver system that receives a digital and/or analog broadcast waves, converts the digital and/or analog broadcast waves into video and audio signals, and outputs the video and audio signals. Here, the receiver system includes: one of the receiver apparatuses described above; and a video display apparatus that displays video based on a video signal outputted from the receiver apparatus and/or outputs audio based on an audio signal outputted from the receiver apparatus.

### BRIEF DESCRIPTION OF THE DRAWINGS

These and other objects and features of the present invention will become clear from the following description, taken in conjunction with the preferred embodiments with reference to the accompanying drawings in which:

FIG. 1 is a block diagram showing an outline of the configuration of a receiver system according to the present invention.

FIG. 2 is a diagram schematically showing how various functional sections are mounted in the receiver apparatus 3 shown in FIG. 1 (top face).

FIG. 3 is a diagram schematically showing how various functional sections are mounted in the receiver apparatus 3 shown in FIG. 1 (bottom face).

FIG. 4 is a block diagram showing an outline of the configuration of a conventional receiver system.

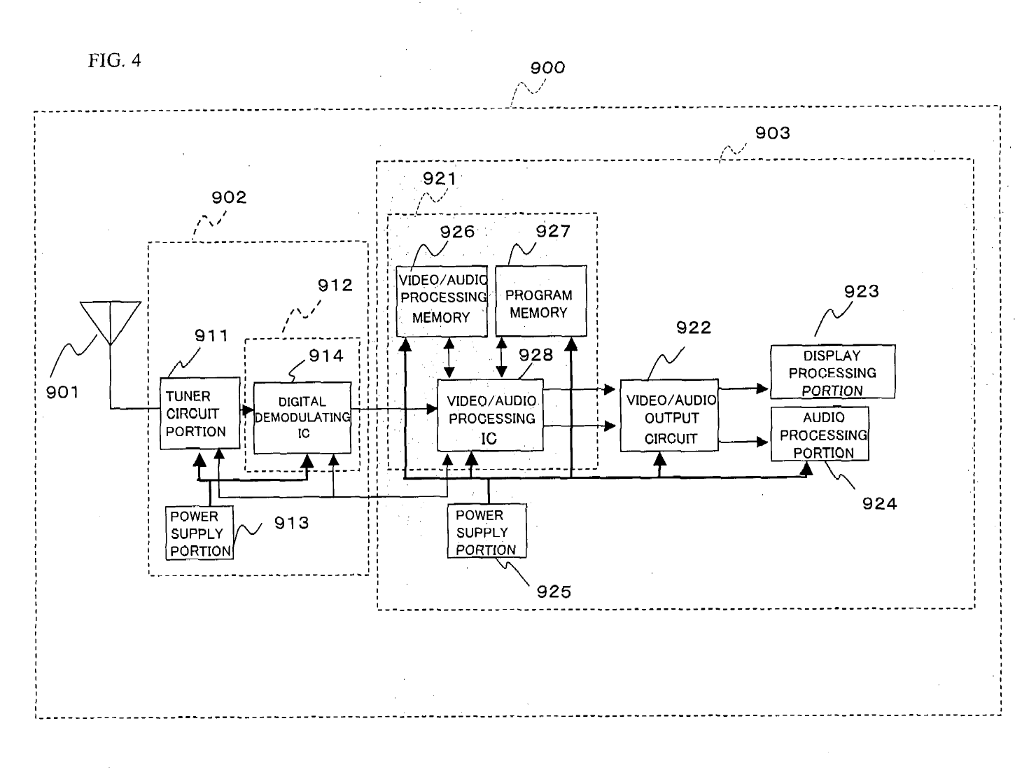

### DETAILED DESCRIPTION OF PREFERRED EMBODIMENTS

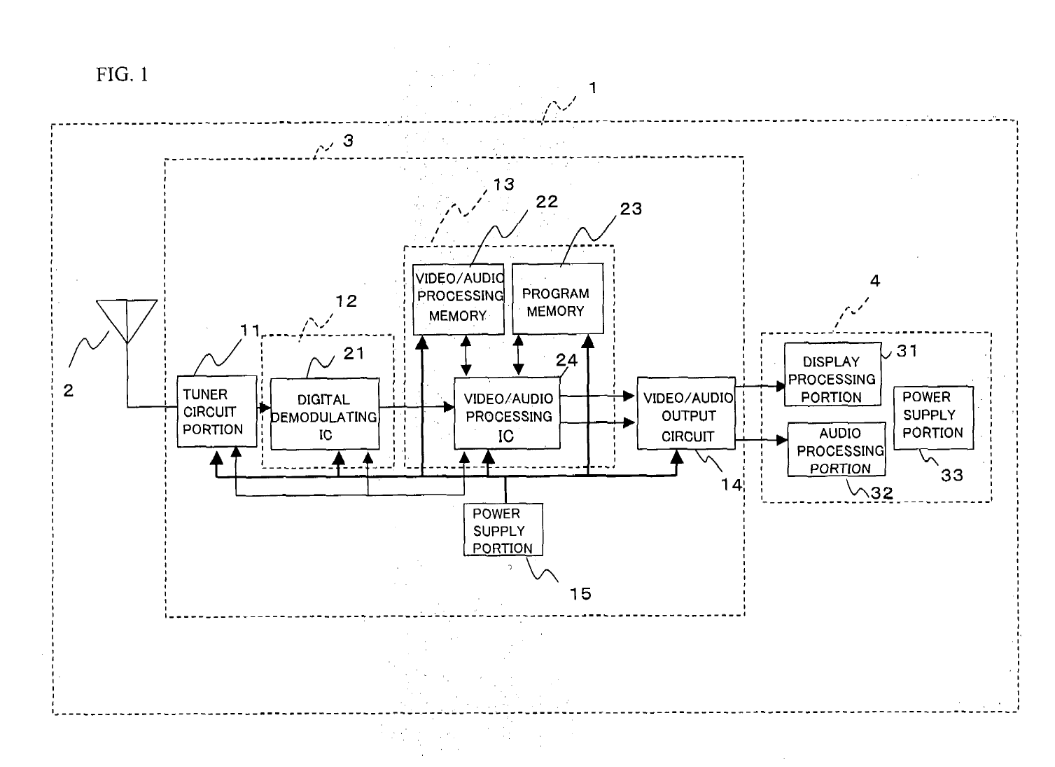

Hereinafter, examples of the configuration of a receiver system embodying the present invention will be described with reference to the accompanying drawings. FIG. 1 is a block diagram showing an outline of the configuration of a receiver system according to the present invention.

The receiver system 1 shown in FIG. 1 is composed of: an antenna 2 via which a radio-frequency signal is received; a receiver apparatus 3 that performs predetermined processing on the signal received via the antenna 2 to acquire video and audio signals; and a video display apparatus 4 that displays video based on the video signal fed from the receiver apparatus 3 and/or outputs audio based on the audio signal fed from the receiver apparatus 3.

The receiver apparatus 3 is provided with: a tuner circuit portion 11 that converts the radio-frequency signal received via the antenna 2 into an intermediate-frequency signal (hereinafter referred to as the “IF signal”), which is to be outputted; a digital demodulating portion 12 that converts the IF signal outputted from the tuner circuit portion 11 into a compressed digital signal, which is to be outputted; a digital circuit portion 13 that converts the compressed digital signal outputted from the digital demodulating portion 12 into digital video and audio signals, which are to be outputted; a video/audio output circuit 14 that converts the digital video and audio signals outputted from the digital circuit portion 13 into analog video and audio signals; a power supply portion 15 that feeds the tuner circuit portion 11, the digital demodulating portion 12, the digital circuit portion 13, and the video/audio output circuit 14 with electric power from which they operate.

Incidentally, the digital demodulating portion 12 is provided with a digital demodulating IC 21, which is a processing IC for converting an IF signal into a digital signal. Also, the digital circuit portion 13 is provided with: a video/audio processing IC 24 for extracting video and audio signals from the compressed digital signal; a video/audio processing memory 22 for storing the compressed digital video and audio signals and demodulated digital video and audio signals; and a program memory 23 for storing control codes for controlling the receiver apparatus.

The video display apparatus 4 is provided with: a display processing portion 31 that performs processing for displaying video based on the analog video signal fed from the receiver apparatus 3; an audio processing portion 32 that performs processing for outputting audio based on the analog audio signal fed from the receiver apparatus 3; and a power supply portion 33 that feeds the display processing portion 31 and the audio processing portion 32 with electric power from which they operate.

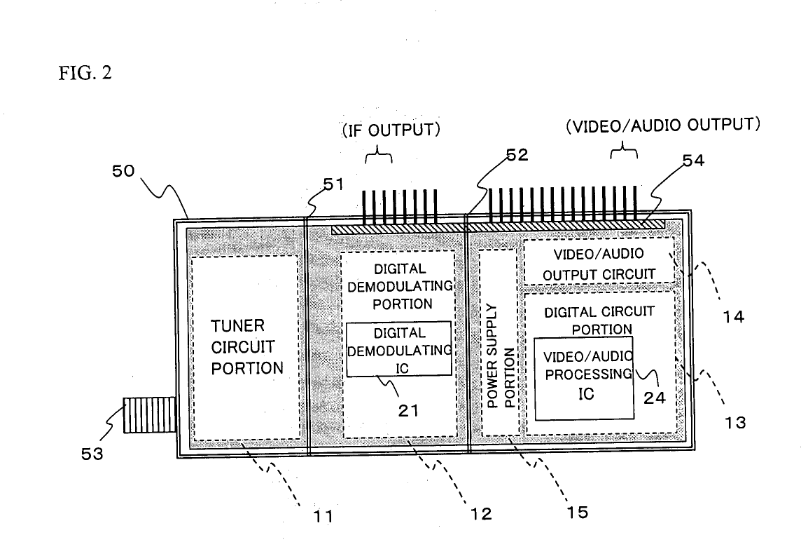

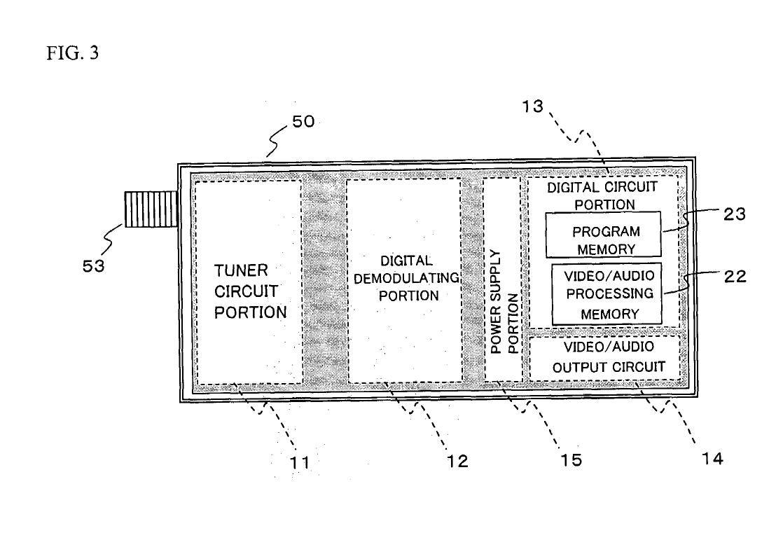

FIGS. 2 and 3 are diagrams schematically showing how various functional sections are mounted in the receiver apparatus 3 shown in FIG. 1. FIG. 2 shows the receiver apparatus 3 as seen from one face (top face) thereof, and FIG. 3 shows the receiver apparatus 3 as seen from the other face (bottom face) thereof.

On the circuit board 50, near a tuner input terminal 53, a tuner circuit portion 11 is mounted. The circuit board 50 is housed in a chassis, and an analog ground pattern of the tuner circuit portion 11 is electrically connected to the chassis. On the circuit board 50, a radio-frequency signal received via the antenna 2 is fed from the tuner input terminal 53 to the tuner circuit portion 1. The chassis has lids fitted thereto, one on the top face and another on the bottom face thereof, and thereby the circuit board 50 is covered with a shield.

On the circuit board 50, in the portion thereof on the side of an edge of the tuner circuit portion 11 opposite to the edge thereof where the tuner input terminal 53 is fitted, a digital demodulating portion 12, a digital circuit portion 13, a video/audio output circuit 14, and a power supply portion 15 are mounted. The block inclusing the tuner circuit portion 11 and the block including the digital demodulating portion 12, the digital circuit portion 13, the video/audio output circuit 14, and the power supply portion 15 are electromagnetically shielded from each other with a first shield plate 51.

Along one edge of the circuit board 50, a connector 54 is provided. The connector 54 includes input and output terminals related to the tuner circuit portion 11, the digital demodulating portion 12, the digital circuit portion 13, the video/audio output circuit 14, and the power supply portion 15.

Within the connector 54, near the tuner circuit portion 11 is arranged the IF output terminal of the tuner circuit portion 11, and via this IF output terminal, an IF signal is outputted. On the other hand, within the connector 54, apart from the tuner circuit portion 11 (in the opposite position) are arranged the output terminal of the video/audio output circuit 14 and the ground terminal thereof.

The digital demodulating portion 12 and the digital circuit portion 13 are electromagnetically shielded from each other with a second shield plate 52. As the circuit board 50, a multiple-layer circuit board is adopted so that the digital demodulating IC 21 provided in the digital demodulating portion 12 and the video/audio processing IC 24 provided in the digital circuit portion 13 are electrically connected together via an interlayer conductor pattern laid inside the circuit board 50. These two ICs are mounted apart from each other on the same face of the circuit board 50. Moreover, the packages of the digital demodulating IC 21 and the video/audio processing IC 24 each make contact with the chassis via a thermally conductive member laid in between.

The digital circuit portion 13 has the video/audio processing IC 24 mounted on one face (top face) thereof, and has the video/audio processing memory 22 and the program memory 23 mounted on the other face (bottom face) thereof. The video/audio processing IC 24, the video/audio processing memory 22, and the program memory 23 are electrically connected together via the interlayer conductor pattern laid inside the circuit board 50. As shown in FIG. 3, on the circuit board 50, the video/audio processing memory 22 is arranged opposite to the tuner circuit portion 11.

The power supply terminals of the tuner circuit portion 11, the digital demodulating portion 12, the digital circuit portion 13, and the video/audio output circuit 14 are arranged, within the connector 54, between the output terminal of the video/audio output circuit 14 and the IF output terminal of the tuner circuit portion 11.

With this configuration, as the result of the digital circuit portion 13 and the video/audio output circuit 14 being mounted on the circuit board of the receiver apparatus 3, the video display apparatus 4 now needs to incorporate only the display processing portion 31 that displays as video the video signal fed from the receiver apparatus 3 and the audio processing portion 32 that outputs as audio the audio signal fed from the receiver apparatus 3. This eliminates the need to adopt a multiple-layer circuit board for the video display apparatus 4.

In the conventional configuration, since the digital circuit portion is provided in the video display apparatus, measures against the unnecessary electromagnetic emission and the noise generated by the video/audio processing IC, the video/audio processing memory, the program memory, and the like need to be taken in the video display apparatus. By contrast, with the configuration according to the present invention, in the receiver apparatus is provided the digital circuit portion, and thus the video display apparatus can be configured without a digital circuit portion. This eliminates the need to take measures against unnecessary electromagnetic emission and noise in the video display apparatus.

The digital demodulating IC 21 and the video/audio processing IC 24 mounted on the circuit board of the receiver apparatus 3 are each connected to the chassis via a thermally conductive member laid in between. Thus, measures against the heat generated by the IC packages are taken. On the other hand, in the video display apparatus, which no longer needs to be provided with IC packages, no measures need to be taken against heat as by increasing the area of the circuit board or providing it with an additional heat-dissipating plate.

Furthermore, in the receiver apparatus, the ground pattern of the functional section of the analog circuit (the tuner circuit portion 11) mounted on the circuit board is separated from the ground pattern of the block including the digital circuits (the digital circuit portion 13, the digital demodulating portion 12, and the video/audio output circuit 14). This makes it possible to prevent the digital noise generated by the digital demodulating portion 12 and the digital circuit portion 13 from entering the tuner circuit portion 11 and thereby to avoid degradation of the performance of the tuner circuit portion 11 as much as possible.

Furthermore, the analog ground pattern and the digital ground pattern are each electrically connected to the chassis. This eliminates the need to ground the block including the analog circuit and the block including the digital circuits. This also helps reduce the impedance between the analog and digital grounds.

The connector 54 is provided along one edge of the circuit board, and, via the connector 54, not only the input and output terminal of the tuner circuit portion 11, but also the input and output terminals related to the digital demodulating portion 12, the digital circuit portion 13, the video/audio output circuit 14, and the power supply portion 15, are each wired. This makes the design of the wiring in the video display apparatus easy.

Within the connector 54, near the tuner circuit portion 11 is arranged the IF output terminal of the tuner circuit portion 11, and via this IF output terminal, the IF signal is outputted. On the other hand, within the connector 54, apart from the tuner circuit portion 111 are arranged the output terminal of the video/audio output circuit 14 and the ground terminal thereof.

Arranging the output terminal of the tuner circuit portion apart from the output terminal of the video/audio output circuit in this way helps prevent radio-frequency noise generated by the tuner circuit portion from entering the video/audio output circuit. Also, digital noise generated by the digital demodulating portion and the digital circuit portion mounted on the same circuit board is prevented from mixing with the IF signal outputted from the tuner circuit portion.

Also, separating the tuner circuit portion 11 from the digital demodulating portion 12, the digital circuit portion 13, the video/audio output circuit 14, and the power supply portion 15 with the first shield plate 51 helps prevent the electromagnetic emission generated by the digital demodulating portion and the digital circuit portion mounted on the same circuit board from entering the tuner circuit portion.

In addition, the digital demodulating portion 12 and the digital circuit portion 13 are separated from each other with the second shield plate 52. This prevents the electromagnetic emission generated by the digital circuit portion from entering the digital demodulating portion.

Also, the digital demodulating IC in the digital demodulating portion and the video/audio processing IC in the digital circuit portion are arranged apart from each other on the same mount face. This permits the heat generated by the digital demodulating IC and the heat generated by the video/audio processing IC to spread out. In addition, the packages of these ICs each make contact with the chassis via a thermally conductive member laid in between. This permits the heat to be dissipated to the chassis and the lids, and thus helps alleviate the accumulation of the heat.

1. A receiver apparatus that converts a radio-frequency signal received via an antenna into video and audio signals, comprising:
a tuner circuit portion that converts the radio-frequency signal received via the antenna into an intermediate-frequency signal;
a digital demodulating portion that converts the intermediate-frequency signal outputted from the tuner circuit portion into a compressed digital signal;
a digital circuit portion that converts the compressed digital signal outputted from the digital demodulating portion into digital video and audio signals; and
a video/audio output circuit that converts the digital video and audio signals outputted from the digital circuit portion into analog video and audio signals,
wherein
the tuner circuit portion, the digital demodulating portion, the digital circuit portion, and the video/audio output circuit are arranged on a single circuit board.

2. The receiver apparatus of claim 1, wherein
an analog ground pattern of a block including the tuner circuit portion and a digital ground pattern of a block including the digital circuit portion, the digital demodulating portion, and the video/audio output circuit are arranged apart from each other on the circuit board.

3. The receiver apparatus of claim 2, wherein
the circuit board is housed inside a chassis, and
the analog ground pattern and the digital ground pattern are electrically connected to the chassis.

4. The receiver apparatus of claim 1, wherein
the digital circuit portion is provided with: a video/audio processing IC that demodulates the compressed digital video and audio signals; and a video/audio processing memory that stores the compressed digital video and audio signals and the demodulated digital video and audio signals, and
on the circuit board, the video/audio processing memory is arranged in an end part of the circuit board opposite from an end part thereof where the tuner circuit portion is mounted, on a face of the circuit board opposite from a face thereof on which the video/audio processing IC is mounted.

5. The receiver apparatus of claim 4, wherein
the digital demodulating portion is provided with a digital demodulating IC, which is a processing IC for converting an intermediate-frequency signal into a digital signal, and
on the circuit board, the digital demodulating IC and the video/audio processing IC are arranged apart from each other on a same mount face.

6. The receiver apparatus of claim 5, wherein
on the circuit board, the digital demodulating IC and the video/audio processing IC each make contact with the chassis via a thermally conductive member laid in between.

7. The receiver apparatus of claim 4, wherein
the circuit board is a multiple-layer circuit board, and
the video/audio processing IC and the video/audio processing memory are wired together via an interlayer conductor pattern.

8. The receiver apparatus of claim 5, wherein
the circuit board is a multiple-layer circuit board, and
the video/audio processing IC and the digital demodulating IC are wired together via an interlayer conductor pattern.

9. The receiver apparatus of claim 1, wherein
on the circuit board, along one edge thereof is arranged a connector that includes input and output terminals of the tuner circuit portion, of the digital demodulating portion, of the digital circuit portion, and of the video/audio output circuit.

10. The receiver apparatus of claim 9, wherein
within the connector, an output terminal and a ground terminal of the video/audio output circuit are arranged in a part of the connector opposite from the tuner circuit portion.

11. The receiver apparatus of claim 9, wherein
within the connector, an IF output terminal for outputting the intermediate-frequency signal obtained through conversion by the tuner circuit portion is arranged near the tuner circuit portion.

12. The receiver apparatus of claim 11, wherein
a power supply portion is provided that feeds electric power to each of the tuner circuit portion, the digital demodulating portion, the digital circuit portion, and the video/audio output circuit, and
within the connector, power supply terminals for feeding electric power to the tuner circuit portion, the digital demodulating portion, the digital circuit portion, and the video/audio output circuit are arranged between the output terminal of the video/audio output circuit and the IF output terminal.

13. The receiver apparatus of claim 1, wherein
a block including the tuner circuit portion is separated from a block including the digital circuit portion, the digital demodulating portion, and the video/audio output circuit with a first shield plate.

14. The receiver apparatus of claim 13, wherein
on the circuit board, the digital demodulating portion and the digital circuit portion are separated from each other with a second shield plate.

15. A receiver system that receives digital and/or analog broadcast waves, converts the digital and/or analog broadcast waves into video and audio signals, and outputs the video and audio signals, the receiver system comprising:
a receiver apparatus of one of claims 1; and
a video display apparatus that displays video based on the video signal outputted from the receiver apparatus and/or outputs audio based on the audio signal outputted from the receiver apparatus.
